(19) United States
(12) Patent Application Publication
(10) Pub. No.: US 2006/0006292 A1
(43) Pub. Date: Jan. 12, 2006

(54) Pipe clip

(75) Inventors: Ralf Kleeb, Baretswil (CH); Roger Huppi, Zurich (CH)

Correspondence Address: NOTARO AND MICHALOS, 100 DUTCH HILL ROAD, SUITE 110, ORANGEBURG, NY, 10962-2100, US

(73) Assignee: PMA AG, Uster (CH)

(21) Appl. No.: 10/527,733

(22) PCT Filed: Aug. 28, 2003
(86) PCT No.: PCT/CH03/00584

§ 371 Date: Mar. 14, 2005

(30) Foreign Application Priority Data
Sep. 25, 2002 (CH) 1613/02

(51) Int. Cl. F16L 3/08

(52) U.S. Cl. 248/74.1

(57) ABSTRACT

The pipe clip comprises an upper part (1) and a lower part (2) connected swivelably with one another by means of a hinge (4). For the closing, securing elements (15, 16) are provided. The pipe clip has a lower supporting face (7) and an upper supporting face (6) which make possible stacking at least two pipe clips. For premounting and attaching on a carrier element (10) in the lower part (2) a bore (8) is provided and an attachment means (9) in the form of a machine screw.

The invention relates to a pipe clip comprising an upper and a lower part, which encompass a throughlet opening for a pipe, these two parts being connected with one another on one side with a hinge and, on the other side, have detachable elements for securing them in position.

Pipe clips of this type are disclosed for example in EP A1 602 456. The pipe clips described in this document are each comprised of a semicircular lower and upper part swivelably connected with one another via a plug hinge. On the side of the two parts of the pipe clip opposite the hinge are disposed lugs. On one of the lugs is located, on the one hand, a nut and, on the other, a machine screw, in order to clamp together the two parts of the pipe clip. In addition, the pipe clip has on one part a threaded nut, which permits attaching the pipe clip on a threaded stud. Such pipe clips are suitable for attaching individual pipes. However, pipes, which are located one above the other in several planes, cannot be attached. In addition, closing the pipe clip via the threaded joint is cumbersome and difficult at sites which are difficult to access. However, especially in motor vehicle fabrication it is often necessary to attach several pipes next to one another and, additionally, it is also possible for several pipes to be disposed one above the other in several layers. Attaching such groups of pipes is in practice only possible with complicated ancillary equipment and requires considerable effort.

The aim of the invention is therefore to provide a pipe clip which can be simply premounted on a carrier element, in particular on a mounting rail, such as are commonly used in motor vehicle fabrication. The pipe clip, moreover, is to be stackable such that several layers of pipes can be disposed one above the other and, simultaneously, the pipe clip is to be simply closable, as well as be suitable for light as well as for heavy loading.

This aim is attained through the characteristics defined in patent claim 1. Advantageous further developments of the invention are defined in the dependent claims.

Disposing one supporting face each on the upper and lower part, these supporting faces being directed outwardly and in parallel, permits the simplified attaching of the lower part on a carrier element and permits the secure stacking of two or more pipe clips of the type according to the invention. In the lower part of the pipe clip is located a bore, which extends from the throughlet opening for the pipe and leads into the supporting face of the lower part. Into this throughlet opening is insertable an attaching means, for example a machine screw, wherewith the lower part of the pipe clip can be attached on a carrier element, for example a nut disposed such that it slides in a mounting rail. Thereby the lower part, or the pipe clip, can be premounted in simple manner. In addition to the detachable securing element of the two parts of the pipe clip, in one side region of the same a throughbore is located which serves for receiving an additional connection element. This connection element permits the additional attaching of the pipe clip on the carrier element and permits in addition an intensified clamping together of the two parts of the pipe clip. This can take place for example with a machine screw, which is inserted through this throughbore and connected in the carrier element with a nut. Through this arrangement additional forces can be absorbed and the pipe clip according to the invention is therefore also suitable for heavy loadings. Extremely heavy loadings can be absorbed if at both side regions of the pipe clip a throughbore is disposed for the additional reception of two connection elements.

The implementation of the detachable securing elements between the upper and the lower part of the pipe clip as a latching closure permits the simple closing of the pipe clip as soon as the pipe has been placed into it. This latching closure connects the upper and the lower part of the pipe clip with sufficiently large closing forces in order to be able to absorb reliably light to medium heavy loadings. In these cases the provision of additional connection elements at the side regions of the pipe clip is not necessary. The latching closure is also readily detachable such that rebuilding of the pipe installations is facilitated. The latching closure is comprised of a resilient connection element disposed on the lower or upper part and a corresponding retaining part disposed on the other part of the pipe clip. These parts engage one another resiliently and in the form of hooks as soon as the upper and the lower part of the pipe clip are closed by swiveling about the hinge. A further advantage is attained thereby that the lower part of the pipe clip comprises side portions which extend beyond the central axis of the throughlet opening for the pipe in the direction toward the upper part. Thereby side guides are formed and these side guides better secure the emplaced pipe in the desired position until the pipe clip is closed. In addition, thereby the possibility is provided that the upper part of the pipe clip no longer forms one half of a structure but can be built smaller. Less space is thereby required for the swiveling-out and pipe clips can be laterally slid directly against one another. Moreover, this disposition permits disposing the hinge between the upper and the lower part at the uppermost edge of the pipe clip. This advantageous structuring also facilitates the lateral sliding together of adjacent pipe clips and permits an optimal and compact disposition of the guided pipes. A further advantage of the disposition according to the invention comprises that the upper part extends only over a range of less than 180° of the circumference of the throughlet opening for the pipe. An end region of the upper part and specifically that, which includes the hinge, is delimited by an imaginary plane placed through the longitudinal axis of the throughlet opening for the pipe and the axis of the hinge between the two parts of the hinge. This disposition permits opening the upper part of the pipe clip without clamping forces being generated between the upper part and the emplaced pipe through the swivel movement. This disposition is especially advantageous if the hinge is disposed above the center plane of the throughlet opening for the pipe.

The embodiment according to the invention of the lower and upper part of the pipe clip permits stacking two or more pipe clips one above the other. For this purpose serve the outwardly directed supporting faces, which extend parallel to one another. The attachment of the pipe clips stacked one above the other takes place with the additional connection elements, which are inserted through at least one of the throughbores in a side region of the pipe clips. Through this mounting option of the pipe clips according to the invention multi-layered pipe bundles can be attached securely and rapidly in simple manner. If the stacked pipe clips are connected with one another with two connection elements, large forces can also be absorbed. In its optimized form it is advantageous if the pipe clip according to the invention in its closed state has a cuboid outer form which includes the throughlet opening for the pipe approximately in its center.

The invention will be explained in further detail on the basis of embodiment examples in conjunction with the drawing. Therein depict:

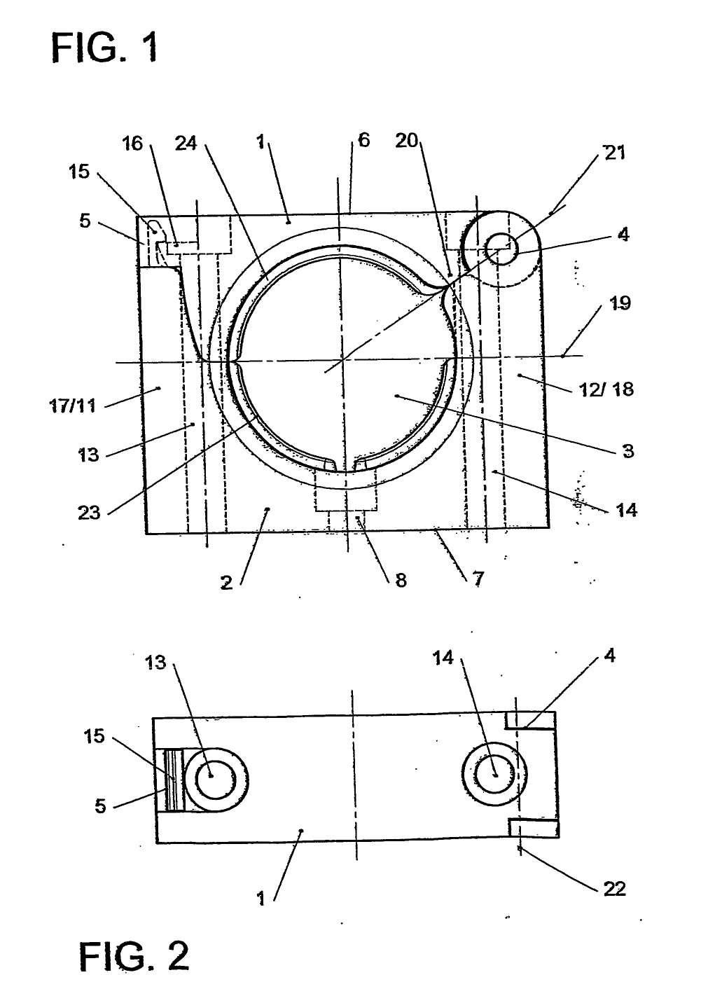

FIG. 1 view of a pipe clip according to the invention in the closed state,

FIG. 2 top view onto the upper side of the pipe clip according to FIG. 1, and

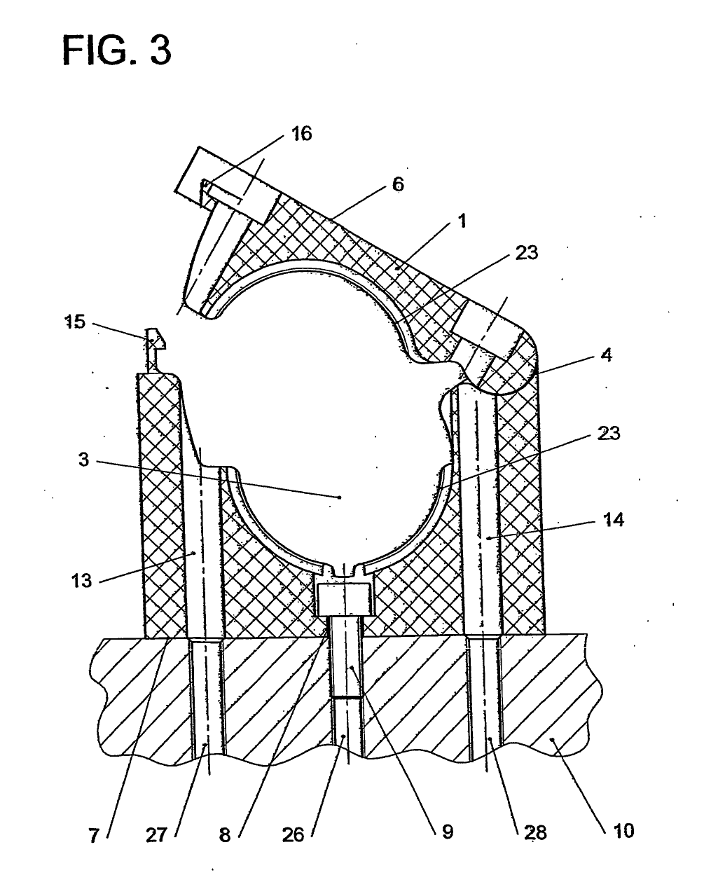

FIG. 3 cross section through a pipe clip according to the invention in the open state.

The pipe clip depicted in FIG. 1 comprises an upper part 1 and a lower part 2. In the closed state these two parts 1, 2 encompass a throughlet opening 3 for a pipe to be secured in a specific position. In the depicted example the pipe clip is one for corrugated pipes, which is the reason for the upper part 1 and the lower part 2 of the pipe clip to have ribs 23 in the proximity of the throughlet opening 3, which ribs engage corresponding depressions on the corrugated pipe. The upper part 1 and the lower part 2 are swivelably connected with one another with a hinge 4. At the opposite side of the pipe clip the upper part 1 and the lower part 2 in the closed state engage one another via detachable securing elements 5, whereby the two parts 1, 2 are maintained in the closed position. These securing elements 5 advantageously are implemented as a latching closure, which, on the one side, comprises a resilient connection element 15 and, on the other side, a retaining part 16. In the depicted example the resilient connection element 15 is located on the lower part 2 and comprises a hook-like detente. The retaining part 16 comprises a cam disposed on the upper part 1, which cam cooperates with the resilient hook of the connection element 15. This securing element 5 permits the ready closing of the pipe clip by swiveling the upper part 1 and pressing together the two elements 15 and 16. After the upper part 1 is completely closed, it is maintained reliably and secured in position relative to the lower part 2 without additional attachment means needing to be actuated or inserted. Therewith a pipe emplaced in the throughlet opening 3 is secured and maintained in the desired position. In the lower part 2 a central bore 8 is located, which serves for the purpose of receiving an attachment means, for example a machine screw 9. This bore 8 is accessible from the throughlet opening 3 as long as the pipe clip is opened and no pipe is emplaced. In this starting position therefore the pipe clip can be attached or premounted on a carrier element 10 with the aid of an attachment means 9 inserted in the bore 8. The carrier element 10 can be any structure of an apparatus or an object or a mounting rail known per se, which comprises sliding nuts. Such mounting rails are utilized for example in motor vehicle fabrication and permit the simple positioning of the pipe clips in the desired position. In the two side regions 11, 12 the pipe clip has additional throughbores 13 and 14 which serve for receiving additional connection elements between the pipe clip and a carrier element 10. In the case of light loadings, the attachment of the pipe clip on the carrier element by means of attachment means 9 suffices, which means is set into bore 8. The latching closure 5 between the upper and the lower part 1, 2 can in this case also absorb the occurring loadings. In the event of heavier loadings an additional connection element, for example a machine screw, can be set into at least one of the throughbores 13, 14, which machine screw is connected with a nut or a threaded bore on the carrier element 10. Thereby a connection between pipe clip and carrier element 10 can be established, which can absorb significantly higher forces. The upper part 1 and the lower part 2 of the pipe clip are simultaneously clamped together and a connection is provided which can absorb high forces. For especially heavy loadings, for example, in the case of railway vehicles, one machine screw each is set into both throughbores 13, 14.

The top view depicted in FIG. 2 onto the upper side of the pipe clip of FIG. 1 according to the invention shows the disposition of the two throughbores 13, 14 and also the engagement of the two pipe clip parts 1, 2 in the proximity of hinge 4. The pipe clip depicted as example has a cuboid outer form in the closed state. The upper part 1 as well as also the lower part 2 have each an outwardly directed supporting face 6 or 7, respectively. These two supporting faces 6, 7 extend parallel to one another and form flat mounting faces. Thereby two or more pipe clips can be set one on top of the other, i.e. stacks of attached pipes can be produced. The attachment of the pipe clips takes place with long machine screws which are inserted through the throughbores 13, 14 and are connected with the carrier element 10. This embodiment permits forming a stack of pipe clips disposed one above the other in very simple manner, without additional carrier elements or connection elements being required between the pipe clips. Side portions 17, 18 of the lower part of the pipe clip extend beyond the center axis 19 of throughlet opening 3 in the direction of the upper part 1. This embodiment entails the additional advantage that pipes emplaced in the throughlet opening 3 are better secured until the upper part 1 is closed.

Since in many application cases several pipes which must be attached with pipe clips, extend one next to the other, there is the wish to dispose these as close as possible next to one another. This becomes possible in the pipe clip according to the invention if the hinge 4 is disposed in that corner in which the extended side part 18 of the lower part 2 and the supporting face 7 of upper part 1 abut one another. Due to this disposition, the upper part 1 during the swivel movement does not need additional space for movements in the side regions next to the pipe clip. This entails the advantage that adjacent pipe clips can abut side face to side face. To make the swiveling of the upper part 1 about the hinge 4 possible, the inner region of the upper part 1 is implemented such that it extends only over a range of less than 180° of the circumference of the throughlet opening 3. In the depicted example this inner region 24 extends only over an angular segment of approximately 140°, this angular segment being delimited, on the one hand, by the center axis 19 of the throughlet opening 3 and, on the other hand, by an imaginary plane 21. This imaginary plane 21 is placed through the central longitudinal axis of the throughlet opening 3 and the axis 22 of the hinge 4. This imaginary plane 21 delimits the end region 20 of the upper part 1. Depending on the structural implementation and disposition of the hinge 4 with respect to the center axis 19, the angular range over which the inner region 24 of upper part 1 extends changes.

Based on the cross section through the pipe clip described by example and depicted in FIG. 3, the attachment of the pipe clip, or of lower part 2, on a carrier element 10 is evident. The carrier element 10 can involve, for example, a housing wall. The carrier element 10 has a threaded bore 26 engaged by machine screw 9 which is placed through bore 8. On both sides of threaded bore 26 in carrier element 10 are located two additional threaded bores 27, 28. These serve for receiving machine screws which are inserted into the throughbores 13 and 14. As depicted, the upper part 1 is swivelable about hinge 4, such that the two parts 1, 2 of the pipe clip can be opened and, in connection with the depicted example, a corrugated pipe can be placed into the throughlet opening 3. The upper part 1 is subsequently closed by swiveling, and by pressing into the lower part 2 the latching closure 5 is effected. The retaining part 16 on upper part 1 latches into the hook on the resilient connection element 15 on the lower part 2, whereby a form- and force-fit connection between the two parts 1, 2 results. Pipe clips of the type according to the invention can be readily and cost-effectively produced with the aid of synthetic material technology. Mounting the pipe clips themselves as well as emplacing the pipes is extremely simple and requires only minimal time expenditures. Only very few parts are necessary since the pipe clip according to the invention is so equipped that it can be premounted by means of conventional means and through the selection of the number of attachment machine screws, the entire range of light and heavy loadings can be covered. Thereby that the pipe clips can be stacked one above the other and therewith subjacent layers of pipes can be attached, considerable time and cost advantages are obtained without additional means becoming necessary.

1. Pipe clip comprising an upper part (1) and a lower part (2) encompassing a throughlet opening (3) for a pipe, these two parts (1, 2) being connected with one another on one side via a hinge (4) and on the other side having detachable securing elements (5), characterized in that the upper part (1) and the lower part (2) have each one supporting face (6, 7) directed outwardly and extending parallel, in the lower part (2) a bore (8) is located accessible from the throughlet opening (3), which bore is intended for receiving attachment means (9) between the pipe clip (1, 2) and a carrier element (10), and at least in one side region (11, 12) of the pipe clip a throughbore (13, 14) for receiving an additional connection element between the pipe clip (1, 2) and the carrier element (10) is provided.

2. Pipe clip as claimed in patent claim 1, characterized in that the detachable securing element (5) on one side of the two parts (1, 2) of the pipe clip is a latching closure and on the lower part (2) or on the upper part (1) a resilient connection element (15) is disposed and, on the other part of the pipe clip, a corresponding retaining part (16).

3. Pipe clip as claimed in patent claim 1, characterized in that the lower part (2) has side portions (17, 18) which extend beyond the center axis (19) of the throughlet opening (3) for the pipe in the direction of the upper part (1).

4. Pipe clip as claimed in claim 1, characterized in that the upper part (1) extends only over a range of less than 180° of the circumference of the throughlet opening (3) for the pipe and an end region (20) of the upper part (1), which includes the hinge (4), is delimited for example by an imaginary plane (21) placed through the longitudinal axis of the throughlet opening (3) for the pipe and the axis (22) of the hinge (4) between the two parts (1, 2) of the pipe clip.

5. Pipe clip as claimed in claim 1, characterized in that both side regions (11, 12) of the pipe clip have each one throughbore (13, 14) for one additional connection element each.

6. Pipe clip as claimed in claim 1, characterized in that several pipe clips can be stacked one above the other and therein the outwardly directed supporting faces (6, 7) between two pipe clips each are in contact on one another as well as the pipe clips are connected with one another by means of at least one connection element inserted through a throughbore (13, 14) in a side region (11, 12) of the pipe clip.

7. Pipe clip as claimed in claim 1, characterized in that in the closed state the pipe clip has a cuboid outer form.
